(19) United States
(12) Patent Application Publication
(10) Pub. No.: US 2012/0039592 A1
(43) Pub. Date: Feb. 16, 2012

(54) VIDEO CAMERA SUPPLEMENTARY WHITE LIGHT CONTROL METHOD

(75) Inventors: Hueng-Lu Chou, Zhongli City (TW); Szu-Chih Lin, Zhongli City (TW)

(73) Assignee: NEOTECH PHOTOELECTRIC INC., Zhongli City (TW)

(21) Appl. No.: 12/856,679

(22) Filed: Aug. 15, 2010

(51) Int. Cl. G03B 15/03; H04N 5/222

(52) U.S. Cl. 396/164; 348/370; 348/E05.029

(57) ABSTRACT

A video camera supplementary white light control method used in a video camera having installed therein a microcontroller, an image pickup device, a light sensor and a filter for controlling the operation of a supplementary lighting device that may be installed in the video camera or disposed outside the video camera. The method is to let the wavelengths beyond the overlapped area of the wavelength range sensed by the image pickup device and the wavelength range of the white light emitted by the supplementary lighting device be removed by the filter, so that the light sensor can receive a predetermined wavelength of light and compute the luminance of the received light, and the microcontroller can compare the luminance data to a reference data and then control the operation of the supplementary lighting device subject to the comparison result.

### BACKGROUND OF THE INVENTION

1. Field of the Invention

The present invention relates to video camera control technology and more particularly, to a video camera supplementary white light control method, which controls the operation of the supplementary lighting device subject to luminance of the scene.

2. Description of the Related Art

For the advantages of image pickup and real-time monitoring characteristics, video cameras are intensively used for crime fighting to protect people's lives and properties. Following development of technology, advanced digital video cameras can be used for remote surveillance and security control.

In the daytime, due to sufficient ambient light, a video camera can catch clear images. However, when at night, due to insufficient ambient light, a video camera cannot catch images. Therefore, an IR camera or IR video camera may be used with a supplementary lighting device at night. Due to the characteristic of being capable to sense white light (visible light) and infrared light (invisible light), an IR camera or IR video camera can be used in daylight as well as at night. However, an IR camera or IR video camera simply can catch black and white images that cannot show picture details. Color shift and overexposure of images captured at night are further problems may be encountered. Further, due to a different focal point between white light (daylight) and infrared light (night), an IR camera or IR video camera must use a lens having a long depth of field, or be equipped with a day/night auto switch for switching to the desired wavelength, thereby increasing the cost. There is known daylight cameras equipped with a supplementary white-light lighting device for use in daylight as well as at night. These daylight cameras eliminate the problems of IR cameras, and save the cost. However, the light emitted by the supplementary white-light lighting device may cause the lighting device control sensor to make an error control, resulting in an image pickup failure. According to conventional techniques, it is to project the supplementary white light onto the field to be photographed, avoiding dispersion of the emitted light to cause a sensor error. However, this method narrows the camera shooting range (due to insufficient light), and increases the dead angle of the camera.

### SUMMARY OF THE INVENTION

The present invention has been accomplished under the circumstances in view. It is one object of the present invention to provide a video camera supplementary white light control method, which uses a filter to remove the unnecessary wavelengths from the light sensor so that the video camera can accurately control the operation of a supplementary lighting device subject to the luminance data computed by the light sensor, avoiding error.

It is another object of the present invention to provide a video camera supplementary white light control method, which allows the video camera and the supplementary lighting device to be separately installed, avoiding fogging to interfere with normal image sensing of the video camera due to a temperature rise.

To achieve these and other objects of the present invention, a video camera supplementary white light control method used in a video camera having installed therein a microcontroller, an image pickup device, a light sensor and a filter for controlling the operation of a supplementary lighting device that may be installed in the video camera or disposed outside the video camera. The method is to let the wavelengths beyond the overlapped area of the wavelength range sensed by the image pickup device and the wavelength range of the white light emitted by the supplementary lighting device to be removed by the filter, so that the light sensor can receive a predetermined wavelength of light and computes the luminance of the received light. Thus, the microcontroller can compare the computed luminance data to a reference data, and then controls the operation of the supplementary lighting device subject to the comparison result.

### BRIEF DESCRIPTION OF THE DRAWINGS

FIG. 1 is a circuit block diagram of a video camera system in accordance with a first embodiment of the present invention.

FIG. 2 is a circuit block diagram of a video camera system in accordance with a second embodiment of the present invention.

FIG. 3 is a circuit block diagram of a video camera system in accordance with a third embodiment of the present invention.

### DETAILED DESCRIPTION OF THE PREFERRED EMBODIMENT

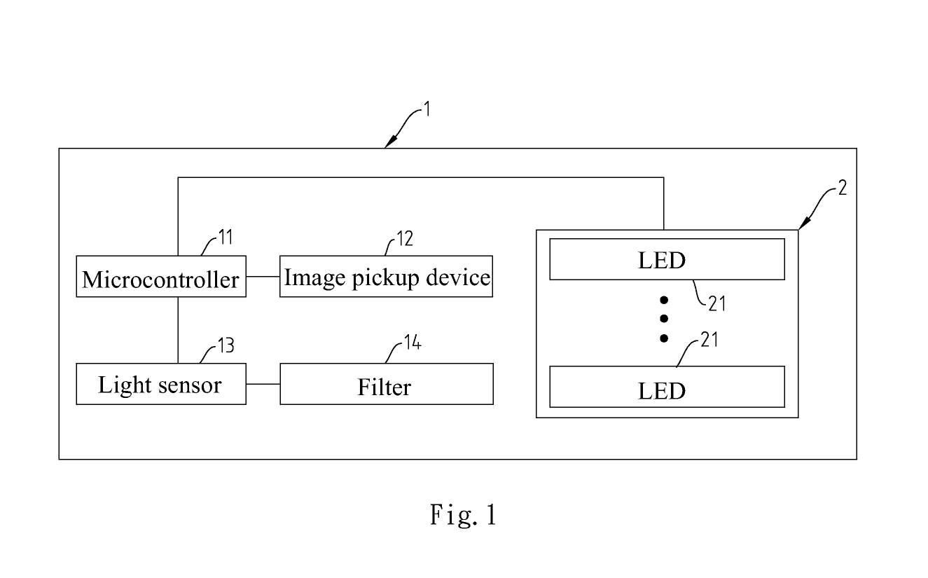

Referring to FIG. 1, a video camera system is shown comprising a video camera 1 and a supplementary lighting device 2.

The video camera 1 has installed therein a microcontroller 11 for operation control, an image pickup device 12 and a light sensor 13 respectively and electrically connected to the microcontroller 11 and a filter 14 connected to the light sensor 13.

The supplementary lighting device 2 is mounted in the video camera 1 and electrically connected to the microcontroller 11, comprising a plurality of white LEDs (light emitting diodes) 21.

When the image pickup device 12 picks up visible light images, the light sensor 13 computes the luminance of the scene sensed by the image pickup device 12. When the light sensor 13 is receiving the light of the scene, the light of the scene goes through the filter 14 into the light sensor 13. When the light passes through the filter 14, the filter 14 removes the unnecessary wavelengths from the light. The wavelengths of light to be removed by the filter 14 are the wavelengths beyond the overlapped area of the wavelength range sensed by the image pickup device 12 and the wavelength range of the light emitted by the white LEDs 21 of the supplementary lighting device 2, so that the light sensor 13 simply receives the light within a predetermined wavelength range for computing the luminance. For example, the image pickup device 12 can sense the light of wavelength 400˜650 nm and the wavelength of the white LEDs 21 is 400˜750 nm, thus the wavelength of the light passing through the filter 14 is 400˜650 nm. After computation of the luminance of the light received by the light sensor 13, the data of the luminance value is transmitted to the microcontroller 11. The microcontroller 11 has a reference luminance range set therein. If the luminance value received from the light sensor 13 is below the reference luminance range, the microcontroller 11 immediately drives the supplementary lighting device 2 to turn on the white LEDs 21, giving light to the scene that is sensed by the image pickup device 12. If the luminance value received from the light sensor 13 surpasses the reference luminance range, the microcontroller 11 immediately drives the supplementary lighting device 2 to turn off the white LEDs 21, stopping the fill light. Thus, the white LEDs 21 of the supplementary lighting device 2 are automatically controlled to emit light or not to emit light subject to the luminance of the scene being sensed by the image pickup device 12.

Therefore, the key technique of the present invention to enhance the function of the video camera 1 is the use of the filter 14 to remove the unnecessary wavelengths from the light of the scene passing to the light sensor 13, i.e., to remove the wavelengths not receivable by the image pickup device 12 and the wavelengths of the light not emitted by the white LEDs 21, so that the light sensor 13 simply receives the light within the predetermined wavelength range for computing the luminance, and the microcontroller 11 can control the supplementary lighting device 2 to turn on/off the white LEDs 21 subject to the luminance of the scene accurately. When using the video camera 1 in the night, the filter 14 removes the unnecessary wavelengths of light, and the microcontroller 11 controls the operation of the white LEDs 21 to regulate the illumination accurately subject to the predetermined luminance range. Further, the fill range of the supplementary lighting device 2 is widened and free, avoiding error of the light sensor 13 due to the illumination of the supplementary lighting device 2.

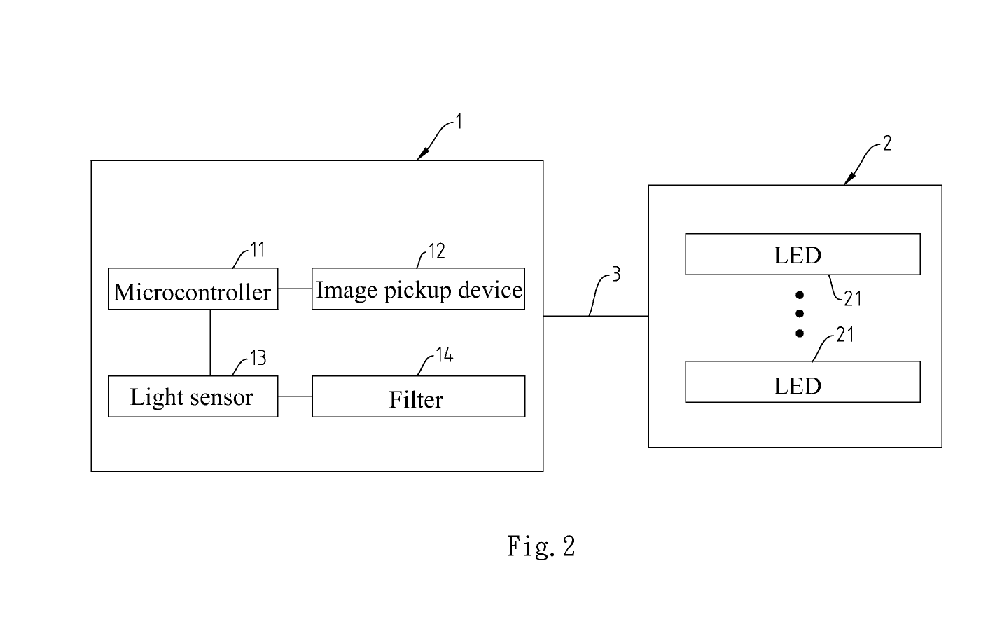

FIG. 2 illustrates an alternate form of the present invention. According to this embodiment, the video camera 1 and the supplementary lighting device 2 are separately provided and electrically connected together by a signal line 3. Thus, the microcontroller 11 can drive the supplementary lighting device 2 to turn on/off the white LEDs 21 through the signal line 3. Thus, the waste heat produced during operation of the white LEDs 21 does not affect the operation of the video camera 1, avoiding fogging due to a rise in temperature.

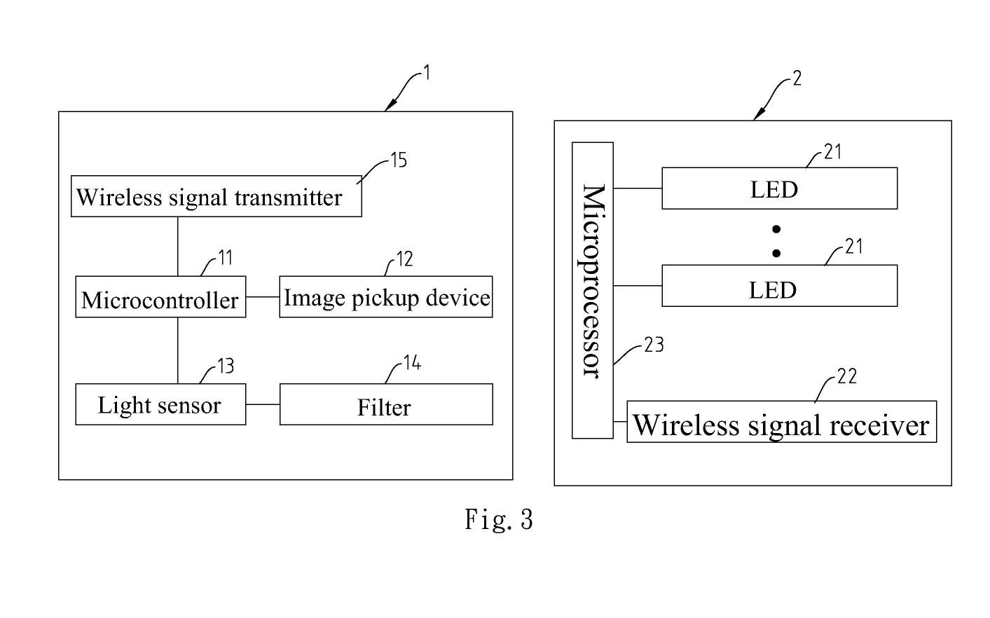

FIG. 3 illustrates another alternate form of the present invention. According to this embodiment, the video camera system comprises a video camera 1 and a supplementary lighting device 2.

The video camera 1 has installed therein a microcontroller 11 for operation control, an image pickup device 12, a light sensor 13 and a wireless signal transmitter 15 respectively and electrically connected to the microcontroller 11, and a filter 14 connected to the light sensor 13.

The supplementary lighting device 2 comprises a plurality of white LEDs (light emitting diodes) 21, a wireless signal receiver 22, and a microprocessor 23. The white LEDs 21 and the wireless signal receiver 22 are respectively electrically connected to the microprocessor 23.

When the image pickup device 12 picks up visible light images, the light sensor 13 computes the luminance of the scene sensed by the image pickup device 12. After computation of the luminance of the light received by the light sensor 13, the data of the luminance value is transmitted to the microcontroller 11 for comparing to the reference luminance range set in the microcontroller 11. Thus, the microcontroller 11 outputs a modulated control signal through the wireless signal transmitter 15 to the wireless signal receiver 22 wirelessly, subject to the comparison result. Upon receipt of the wireless control signal by the wireless signal receiver 22, the modulated control signal is demodulated by the microprocessor 23 for controlling the white LEDs 21, giving light to the scene that is sensed by the image pickup device 12.

If the luminance value received from the light sensor 13 surpasses the reference luminance range, the microcontroller 11 immediately sends a wireless control signal to the supplementary lighting device 2 wirelessly to turn off the white LEDs 21, stopping the fill light. By means of wireless signal transmission control, the supplementary lighting device 2 can be installed in any desired place within a certain distance away from the video camera 1.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A video camera supplementary white light control method used in a video camera system comprising a video camera having installed therein a microcontroller, an image pickup device, a light sensor and a filter, and a supplementary lighting device adapted for emitting white light to the scene to be sensed by said image pickup device, the video camera supplementary white light control method comprising the steps of:
a) using said filter to remove the wavelengths beyond the overlapped area of the wavelength range sensed by said image pickup device and the wavelength range of the white light emitted by said supplementary lighting device for enabling said light sensor to receive a predetermined wavelength of light;
b) driving said light sensor to compute the luminance of the received light and to provide the computed luminance data to said microcontroller;
c) enabling said microcontroller to compare the luminance data obtained from said light sensor to a predetermined reference luminance range and to output a control signal for controlling the operation of said supplementary lighting device subject to the comparison result.

2. The video camera supplementary white light control method as claimed in claim 1, wherein said filter allows the light of wavelength 400˜650 nm to pass therethrough.

3. The video camera supplementary white light control method as claimed in claim 1, wherein said supplementary lighting device comprises a plurality of white lighting emitting diodes.

4. The video camera supplementary white light control method as claimed in claim 1, wherein said supplementary lighting device is installed in said video camera.

5. The video camera supplementary white light control method as claimed in claim 1, wherein said supplementary lighting device is disposed outside said video camera and electrically connected to said microcontroller of said video camera by a signal line.

6. The video camera supplementary white light control method as claimed in claim 1, wherein said supplementary lighting device is disposed outside said video camera for communication with said microcontroller of said video camera by a wireless signal transmitter and receiver system, said wireless signal transmitter and receiver system comprising a wireless signal transmitter installed in said video camera and electrically connected to said microcontroller, a microprocessor installed in said supplementary lighting device and electrically connected with white light emitting devices in said supplementary lighting device and a wireless signal receiver installed in said supplementary lighting device and electrically connected to said microprocessor.
